(19) United States
(12) Patent Application Publication
(10) Pub. No.: US 2026/0164424 A1
(43) Pub. Date: Jun. 11, 2026

(54) METHOD AND APPARATUS FOR MANAGING SURVIVAL TIMER IN WIRELESS COMMUNICATION SYSTEM

(71) Applicant: Samsung Electronics Co., Ltd., Gyeonggi-do (KR)

(72) Inventors: Milos TESANOVIC, Surrey (GB); Sangkyu BAEK, Gyeonggi-do (KR)

(21) Appl. No.: 18/705,201

(22) PCT Filed: Nov. 2, 2022
(86) PCT No.: PCT/KR2022/017007

§ 371 Date: Apr. 26, 2024

(30) Foreign Application Priority Data
Nov. 2, 2021 (GB) 2115747.4
Oct. 11, 2022 (GB) 2214970.2

(51) Int. Cl. H04W 72/12; H04L 1/08; H04W 76/20; H04W 80/02

(52) U.S. Cl. CPC H04W 72/12; H04L 1/08; H04W 76/20; H04W 80/02

(57) ABSTRACT

The disclosure relates to a 5G or 6G communication system for supporting a higher data transmission rate. A user equipment (UE) receives configuration information including survival time state information indicating whether a data radio bearer (DRB) corresponding to the configuration information supports a survival time state; the UE receives configured retransmission grant addressed by configured scheduling-radio network temporary identifier (CS-RNTI); and the UE triggers activation of packet data convergence protocol (PDCP) duplication for all radio link control (RLC) entities configured for the DRB, based on the survival time state information and the configured retransmission grant.

### Technical Field

The present disclosure relates to wireless communication technology, in particular to a method and a device for scheduling enhancements considering Quality of Service, QoS, requirements by managing SURVIVAL TIMER.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

In order to further scheduling enhancements considering QOS requirements such as latency and jitter, it may be necessary to avoid reliance on network's implementation of smart scheduling.

### Solution to Problem

The present application provides a method performed by a user equipment (UE), which includes the following. A UE receives configuration information including survival time state information indicating whether a data radio bearer (DRB) corresponding to the configuration information supports a survival time state, receives configured retransmission grant addressed by configured scheduling-radio network temporary identifier (CS-RNTI), and triggers activation of packet data convergence protocol (PDCP) duplication for all radio link control (RLC) entities configured for the DRB, based on the survival time state information and the configured retransmission grant.

### Advantageous Effects of Invention

The present disclosure provides uplink scheduling enhancements considering Quality of Service, QoS, requirements such as latency and jitter, avoiding reliance on the network's implementation of smart scheduling.

### BRIEF DESCRIPTION OF DRAWINGS

FIG. 1 is a timing diagrams illustrating the basic issue underlying the use of a Survival Timer, ST.

FIG. 2 is a timing diagrams illustrating the basic issue underlying the use of a Survival Timer, ST.

FIG. 3 is a timing diagram illustrating Listen Before Talk, LBT, failure and no indication thereof by a lower layer; and

FIG. 4 is a timing diagram illustrating Listen Before Talk, LBT, failure and an indication thereof by a lower layer, according to an embodiment of the invention.

FIG. 5 is a block diagram of a structure of the UE.

FIG. 6 is a block diagram of a structure of the base station.

### BEST MODE FOR CARRYING OUT THE INVENTION

The present application adopts the following technical solutions: a method performed by a user equipment (UE), the method comprising: receiving configuration information including survival time state information indicating whether a data radio bearer (DRB) corresponding to the configuration information supports a survival time state; receiving, configured retransmission grant addressed by configured scheduling-radio network temporary identifier (CS-RNTI); triggering activation of packet data convergence protocol (PDCP) duplication for all radio link control (RLC) entities configured for the DRB, based on the survival time state information and the configured retransmission grant.

Preferably, a logical channel associated with the DRB is multiplexed in a medium access control (MAC) protocol data unit (PDU), the activation of the PDCP duplication is triggered.

Preferably, configuration information including survival time state information is received via radio resource control signal.

A method performed by a base station, the method comprising: transmitting configuration information including survival time state information indicating whether a data radio bearer (DRB) corresponding to the configuration information supports a survival time state; and transmitting, configured retransmission grant addressed by configured scheduling-radio network temporary identifier (CS-RNTI) to a user equipment (UE), wherein activation of packet data convergence protocol (PDCP) duplication for all radio link control (RLC) entities configured for the DRB is triggered at the UE, based on the survival time state information and the configured retransmission grant.

Preferably, a logical channel associated with the DRB is multiplexed in a medium access control (MAC) protocol data unit (PDU), the activation of the PDCP duplication is triggered.

Preferably, configuration information including survival time state information is received via radio resource control signal.

A user equipment (UE) comprising: a transceiver; and at least one processor coupled with the transceiver and configured to: receive configuration information including survival time state information indicating whether a data radio bearer (DRB) corresponding to the configuration information supports a survival time state, receive, configured retransmission grant addressed by configured scheduling-radio network temporary identifier (CS-RNTI), and trigger activation of packet data convergence protocol (PDCP) duplication for all radio link control (RLC) entities configured for the DRB, based on the survival time state information and the configured retransmission grant.

A base station comprising: a transceiver; and at least one processor coupled with the transceiver and configured to: transmit configuration information including survival time state information indicating whether a data radio bearer (DRB) corresponding to the configuration information supports a survival time state, and transmit, configured retransmission grant addressed by configured scheduling-radio network temporary identifier (CS-RNTI) to a user equipment (UE), wherein activation of packet data convergence protocol (PDCP) duplication for all radio link control (RLC) entities configured for the DRB is triggered at the UE, based on the survival time state information and the configured retransmission grant.

### MODE FOR THE INVENTION

The present invention relates to scheduling in a telecommunication network, particularly uplink scheduling enhancements considering Quality of Service, QoS, requirements such as latency and jitter, avoiding reliance on the network's implementation of smart scheduling. The invention finds particular use in a Fifth Generation, 5G, network using New Radio, NR, but may be employed in this or other telecommunication systems.

In recent years, to cater to market needs, 3GPP has enhanced its portfolio of LTE (Long Term Evolution) radio technology standards to include IoT (Internet of Things)/MTC (Machine-Type Communication) applications. IoT comprises smart sensors collaborating directly without human involvement. There is a myriad of proprietary and standardized IoT connectivity solutions, with widely varying coverage area/connection range, Quality of Service (QoS) guarantees, reliability, and cost. Standardized, wide-area (cellular) based solutions are of special importance for Industrial Internet of Things (IIoT), a key component of Industry 4.0.

The second phase of the NR standards, i.e. Release 16, was completed functionally in June 2020, and now supports enhanced features for targeted services including IIoT. IIoT is one of the core work items of the Release 16 package that supports wireless communications functionalities for IIoT applications such as factory automation, electric power distributions and audio/video streaming.

Although Release 16 NR provides extensive tools for IIoT, there is still room for further enhancements. In August 2020, 3GPP started the next phase of IIoT enhancements within its Release 17 work, which will define additional functions, including:
IIoT services in unlicensed bands, where spectrum is shared with other non-3GPP devices
Propagation delay compensation to increase the synchronization accuracy
Further uplink scheduling enhancements considering QoS requirements such as latency and jitter, avoiding reliance on network's implementation of smart scheduling.

This invention aims to focus on the final point above and aims to provide solutions to specific problems which have been identified as part of 3GPP RAN 2 work on a concept called survival time. Survival time, ST, is defined in 3GPP TS 22.104 as “the time that an application consuming a communication service may continue without an anticipated message”.

According to the 3GPP framework, the maximum survival time indicates the time period that the communication service may not meet the application's requirement before the communication service is deemed to be in an unavailable state. The system is considered unavailable if an expected message is not received within a specified time, which, at minimum, is the sum of maximum allowed end-to-end latency plus survival time. In other words, the survival time indicates to the communication service the time available to recover from failure. In a sense, it represents the difference between reliability of a network, and availability of a service.

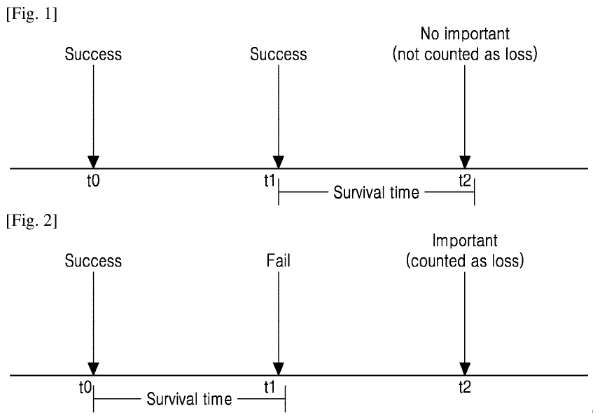

FIG. 1 shows a representation of the issue in terms of a timing diagram. If a transmission at time t1 is successful and the next transmission occurs within the survival time (at time t2), it is tolerable not to receive the transmission at t2. The loss of packet at t2 is not counted as “loss” in calculation of the availability of a service. The transmission at t2 can even be skipped.

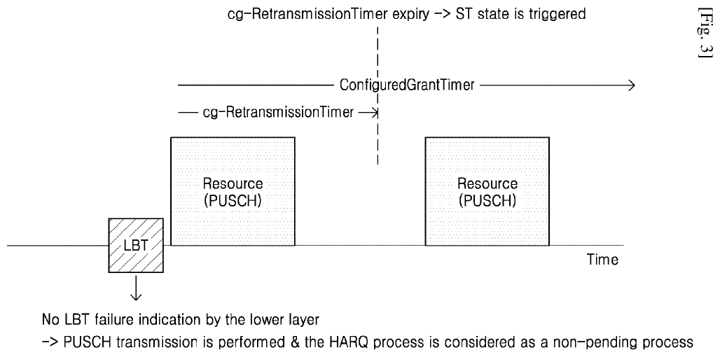

However, FIG. 2 shows a different scenario which assumes that the transmission at time t1 failed, such that the transmission at time t2 becomes important in determining the availability of a service.

3GPP is studying (TR 23.700) how to transfer details of the survival time to the Radio Access Network, RAN. How and when to apply Survival Time assistance information is then up to RAN Working Groups and this is something that is expected to be resolved in Release 17.

To this end, various agreements have been reached.

These include, for instance, the time period during which “message loss” can be tolerated is adopted as the preferred format for Survival time. It is For Future Study, FFS, to determine how this will be achieved and what message loss means in RAN. Other agreements were made, which are not pertinent to details of the present invention.

In the light of these prior discussions and agreements regarding the evolution of the technical standard, it is an aim of embodiments of the present invention to address shortcomings therein, whether disclosed explicitly or not.

According to the present invention there is provided an apparatus and method as set forth in the appended claims. Other features of the invention will be apparent from the dependent claims, and the description which follows.

According to an aspect of the invention there is provided a procedure for use of survival time in RAN, aligned with the aforementioned agreements and focused on the following two aspects:
1. Triggering of entry into ST state for different cases of mapping between DRBs (Data Radio Bearers) and CG (Configured Grant) resources. Note that 5G defines the use of CG scheduling for uplink transmissions that eliminates the need to request and assign resources for each packet transmission by pre-allocating resources to the UE.
2. Operation of ST in unlicensed bands.

Throughout this application, when the term “arranged” is used, this is intended to mean “configured”, “indicated” or “noted”. The exact context is apparent from the usage. For instance, if a function or entity is “arranged” in a certain way, this may mean that an explicit configuration has been performed or a parameter has been set to indicate a specific feature or it may simply mean that the function or entity is operating as per an agreement.

According to a first aspect of the present invention, there is provided a method for determining if a logical channel or radio bearer is to enter a state of modified reliability, wherein the step of determining is performed in response to confirmation of failed reception of a most recent transmission on a radio resource grant carrying data pertaining to the logical channel or radio bearer.

In an embodiment, there is further provided the step of examining the content of the most recent transmission on the radio resource grant.

In an embodiment, there is further provided the step of examining whether the logical channel or radio bearer is arranged by the network to be permitted to enter the state of modified reliability.

In an embodiment, if a first radio bearer (DRB1) is arranged to be permitted to enter the state of modified reliability and a second radio bearer (DRB2) is not so arranged, and data for both DRB1 and DRB2 have been transmitted and a confirmation of failed reception is received for a resource used by both DRB1 and DRB2, then it is determined that only DRB1 is to enter into the state of modified reliability.

In an embodiment, there is further provided the step of examining whether a radio resource grant is arranged by the network to carry data pertaining to a logical channel or radio bearer permitted to enter the state of modified reliability.

In an embodiment, if a resource arranged to be used by a first radio bearer (DRB1) and a second radio bearer (DRB2) is configured to carry the logical channel or radio bearer permitted to enter the state of modified reliability, and a confirmation of failed reception is received for the resource, and it is determined that only data for DRB1 have been transmitted using the resource, then it is determined that only DRB1 is to enter into the state of modified reliability.

In an embodiment, if a resource arranged to be used by a first radio bearer and (DRB1) and a second radio bearer (DRB2) is configured to carry the logical channel or radio bearer permitted to enter the state of modified reliability, and a confirmation of failed reception is received for the resource, then it is determined that both DRB1 and DRB2 are to enter into the state of modified reliability, regardless of whether DRB1 or DRB2 or neither were transmitted using the resource.

In an embodiment, if a first resource and a second resource are arranged to be used by a first radio bearer (DRB1), and a confirmation of failed reception is received for the first resource, then it is determined that DRB1 is to enter into the state of modified reliability if the second resource is configured to carry the logical channel or radio bearer permitted to enter the state of modified reliability.

In an embodiment, if a first resource and a second resource are arranged to be used by a first radio bearer (DRB1), and a confirmation of failed reception is received for the first resource, then it is determined that DRB1 is not to enter into the state of modified reliability if the second resource is configured to carry the logical channel or radio bearer permitted to enter the state of modified reliability.

In an embodiment, the resource is a Configured Grant, CG.

In an embodiment, the confirmation of failed reception is provided in the form of a NACK.

In an embodiment, there is further provided the step of entering the state of modified reliability if it is determined that the logical channel or radio bearer is to enter the state of modified reliability.

In an embodiment, the state of modified reliability comprises entry into a Survival Time, ST, state.

In an embodiment, entering the state of modified reliability comprises applying packet data convergence protocol (PDCP) duplication to at least the logical channel or radio bearer.

In an embodiment, confirmation of the failed reception of the most recent transmission on the logical channel or radio bearer comprises retransmission grant from the network, addressed to configured scheduling-radio network temporary identifier (CS-RNTI) corresponding to a Configured Grant, CG, used for the most recent transmission.

In an embodiment, entry into the state of modified reliability is only allowed for a logical channel or radio bearer configured with a particular RRC parameter.

In an embodiment, entry into the state of modified reliability is only allowed for a logical channel or radio bearer configured to use a resource configured with a particular RRC parameter to carry data pertaining to a logical channel or radio bearer permitted to enter the state of modified reliability.

According to a second aspect of the present invention, there is provided a method of operating a telecommunication system operable in an unlicensed band where a Configured Grant Retransmission Timer, CGRT, is configured and whereby entry into a Survival Time, ST, state is effected if one of the following events occurs:
a) the CGRT expires;
b) there is a Listen Before Talk, LBT, failure of a CG transmission; and
c) the CGRT is stopped.

According to a third aspect of the present invention, there is provided an apparatus arranged to perform the method of any of the preceding aspects.

In an embodiment, the apparatus comprises a telecommunication network and at least one User Equipment, UE.

Embodiments of the invention find particular utility in the area of Time Sensitive Communications (TSC), as defined in TS 23.501. TSC is a communication service that supports deterministic communication and/or isochronous communication with high reliability and availability. Examples of such services are used in the area of Industrial Internet of Things (IIoT), e.g. related to cyber-physical control applications.

To support uplink periodic traffic of services with survival time requirement, configured grant (CG) resources can be used such that the mapping relation between the service and the CG is known to both gNB and UE, thus allowing the gNB to use CG retransmission scheduling (addressed by CS-RNTI) to trigger survival time state entry for the corresponding DRB. Upon survival time state entry, all radio link control (RLC) entities configured for the DRB are activated by the UE for duplication to prevent failure of subsequent messages and hence fulfilling the survival time requirement. If Carrier Aggregation, CA, or Dual Connectivity, DC, duplication for the DRB is already activated, the DRB should enter survival time state when any retransmission grant for any of its active Logical Channels, LCHs, is received.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

FIGS. 1 and 2 show timing diagrams illustrating the basic issue underlying the use of a Survival Timer, ST;

FIG. 3 shows a timing diagram illustrating Listen Before Talk, LBT, failure and no indication thereof by a lower layer; and

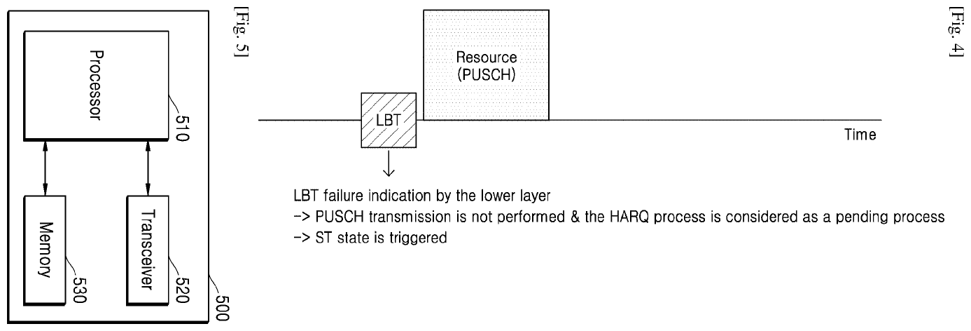

FIG. 4 shows a timing diagram illustrating Listen Before Talk, LBT, failure and an indication thereof by a lower layer, according to an embodiment of the invention.

According to a first embodiment of the invention, there is provided a method for determining a logical channel or radio bearer which may enter a state of modified reliability in response to one of:
a lack of confirmation of successful reception of a most recent transmission on the logical channel or radio bearer; and
confirmation of failed reception of the most recent transmission on the logical channel or radio bearer.

The method further comprising one or more of:
determining a relationship between the logical channel or radio bearer, and radio resource to which the logical channel or radio bearer is mapped; and
examining the content of the most recent transmission on the radio resource.

In an embodiment, modified reliability comprises entry into Survival Time state, wherein Survival Time is a time that an application consuming a communication service may continue without an anticipated message, or any other relevant 3GPP or other definition of Survival Time.

In an embodiment, modified reliability comprises one or more of applying PDCP duplication to at least the selected logical channel or radio bearer, modifying L1/L2 parameters, such as lower order modulation and/or lower coding rate, for transmission of data pertaining at least in part to the selected logical channel or radio bearer.

In an embodiment, confirmation of failed reception of the most recent transmission on the logical channel or radio bearer comprises retransmission grant from the network, addressed to CS-RNTI corresponding to the Configured Grant used for the most recent transmission.

In an embodiment, confirmation of failed reception of the most recent transmission on the logical channel or radio bearer comprises retransmission grant from the network, addressed to C-RNTI corresponding to the Dynamic Grant used for the most recent transmission.

According to a further embodiment of the invention, there is provided a method for determining which logical channel or radio bearer enters a state of modified reliability when it is not possible to determine confirmation of successful reception or lack thereof, the method comprising one or more of:
determining if a change of state has occurred for a timer or a counter prohibiting retransmissions configured for the resource used by the radio bearer or logical channel; and
determining if a failure has occurred in a lower layer to secure a reliable transmission channel to be used by the radio bearer or logical channel.

In an embodiment, the step of determining which logical channel or radio bearer enters a state of modified reliability when it is not possible to determine confirmation of successful reception or lack thereof comprises one or more of transmission in unlicensed spectrum and an inability by a receiving end to determine a corresponding hybrid automatic repeat request (HARQ) process used for the transmission.

In an embodiment, the step of determining if a change of state has occurred for a timer or a counter prohibiting retransmissions comprises the use of cg-RetransmissionTimer.

In an embodiment, a change of state comprises stopping the timer, or the expiry of the timer. In an embodiment, a change of state comprises a counter reaching a certain threshold or being reset.

In an embodiment, the step of determining if a failure has occurred in a lower layer comprises determining if listen-before-talk, LBT, failure has occurred.

In an embodiment of the invention, one issue is how the UE identifies which DRBs should enter the ST state, assuming Configured Grant, CG, retransmission scheduling (addressed by CS-RNTI) is used for Survival Time state triggering.

If there is one-to-one mapping between CG resource and DRB space, there is no difference between per-CG and per-DRB triggering (although the signalling configuration may be different within the specific embodiments). However, for the very common case of multiple DRBs/LCHs using the same CG resource, and for the case where the same DRB/LCHs can use different CG resources, embodiments provide a process for deciding whether entry into ST state should be triggered for different cases of mapping between DRBs and CG resources:
Per-CG triggering (ST trigger is configured per CG configuration, e.g. as part of changes to Information Element, IE, ConfiguredGrantConfig captured in TS38.331, such as the introduction of a new field or parameter indicating that the CG is configured with ST): Assuming DRB1 and DRB2 are both allowed to use CG1 but only data for DRB1 has been transmitted, if a ‘HARQ-NACK’ (shorthand for a retransmission request for the network—it does not have to be a physical HARQ-NACK message—and can be embodied instead by e.g. retransmission grant from the network such as CG retransmission grant, addressed by CS-RNTI) is received, both DRB1 and DRB2 trigger entry into ST state (this does not require the UE to check the content of a previously assembled and transmitted medium access control (MAC) protocol data unit (PDU))
Per-CG triggering (ST trigger is configured per CG configuration) with packet inspection: Assuming DRB1 and DRB2 are both allowed to use CG1 but only data for DRB1 has been transmitted, if a ‘NACK’ is received, only DRB1 triggers entry into ST state (this requires the UE to check the content of a previously assembled and transmitted MAC PDU)
Per-DRB triggering (ST trigger is configured per DRB configuration, e.g. as part of changes to IE LogicalChannelConfig captured in TS38.331, such as the introduction of a new field or parameter indicating that the DRB/LCH is configured with ST): Assuming only DRB1 is configured with ST-based duplication and DRB2 is not, and data for both DRB1 and DRB2 have been transmitted and NACK is received for the CG resource used by both DRB1 and DRB2, only DRB1 triggers entry into ST state (this requires the UE to check the content of a previously assembled and transmitted MAC PDU)
(Case of multi-CG configuration) Assuming DRB1 is allowed to use CG1 and CG2 in Cell 1 and ‘HARQ-NACK’ is received for MAC PDU sent via CG1, if CG2 is configured with ST-based duplication:
   DRB1 enters ST state
   DRB1 does not enter ST state

Embodiments of the present invention also address the use of ST in unlicenced bands. When operating in unlicensed bands where cg-RetransmissionTimer (CGRT) is configured, the network may not know which specific HARQ process has been used for the uplink transmission, and therefore the agreed ST triggering mechanisms (as detailed previously) may not work.

How the retransmission grant is provided for ST state trigger of a RB (Radio Bearer) in unlicensed spectrum has not been previously defined, but an embodiment of the present invention provides:
Entry into ST state is triggered when cg-RetransmissionTimer (CGRT) expires, as shown in FIG. 3.
   If this timer is configured, the gNB may not know which HARQ process is used for the uplink transmission. In this case, a retransmission request by CS-RNTI may be impossible, and the HARQ NACK-based ST triggering may not work. CGRT expiry is therefore used as a trigger for entry into ST state.
Entry into ST state is triggered by LBT (listen-before-talk) failure of CG transmission (i.e. corresponding Physical Uplink Shared Channel (PUSCH) transmission/Uplink Shared Channel (UL-SCH)) as indicated by the lower layer(s), as shown in FIG. 4.
Entry into ST state is triggered when cg-RetransmissionTimer is stopped.

FIG. 5 is a block diagram of a structure of the UE according to an embodiment of the disclosure.

Referring to FIG. 5, the UE according to the disclosure may include a processor 510, a transceiver 520, and a memory 530. According to the above-described communication method of the UE, the processor 510, the transceiver 520, and the memory 530 of the UE may operate. However, components of the UE are not limited to the above-described example. For example, the UE may include components that are more than or fewer than the above-described components. Moreover, the processor 510, the transceiver 520, and the memory 530 may be implemented in the form of a single chip. The processor 510 may refer to one or more processors.

The transceiver 520 may collectively refer to a receiver and a transmitter of the UE, and transmit and receive a signal to and from the base station. The signal transmitted and received to and from the base station may include control information and data. To this end, the transceiver 520 may include an RF transmitter that up-converts and amplifies a frequency of a transmission signal and an RF receiver that low-noise-amplifies a received signal and down-converts a frequency. However, this is merely an example of the transceiver 520, components of which are not limited to the RF transmitter and the RF receiver.

The transceiver 520 may receive a signal through a radio channel and output the received signal to the processor 510, and transmit a signal output from the processor 510 through the radio channel.

The memory 530 may store programs and data required for an operation of the UE. The memory 530 may also store control information or data included in a signal obtained by the UE. The memory 530 may include a storage medium, such as ROM, RAM, hard-disk, CD-ROM, DVD, and the like, or a combination thereof.

The processor 510 may control a series of processes such that the UE operates according to the above-described embodiment of the disclosure. For example, the processor 510 may control components of the UE to perform the method of managing barring according to an embodiment of the disclosure. For example, the transceiver 520 may receive a data signal including a control signal, and the processor 510 may determine a reception result for the data signal.

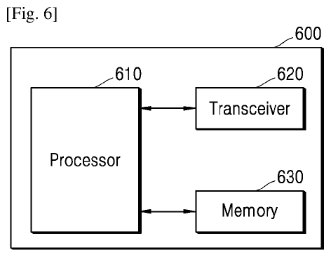

FIG. 6 is a block diagram of a structure of the base station according to an embodiment of the disclosure.

Referring to FIG. 6, the base station according to the disclosure may include a processor 610, a transceiver 620, and a memory 630. According to the above-described communication method of the base station, the processor 610, the transceiver 620, and the memory 630 of the base station may operate. However, components of the base station are not limited to the above-described example. For example, the base station may include components that are more than or fewer than the above-described components. Moreover, the processor 610, the transceiver 620, and the memory 630 may be implemented in the form of a single chip. The processor 610 may refer to one or more processors.

The transceiver 620 may collectively refer to a receiver and a transmitter of the base station, and transmit and receive a signal to and from the UE. The signal transmitted and received to and from the base station may include control information and data. To this end, the transceiver 620 may include an RF transmitter that up-converts and amplifies a frequency of a transmission signal and an RF receiver that low-noise-amplifies a received signal and down-converts a frequency. However, this is merely an example of the transceiver 620, components of which are not limited to the RF transmitter and the RF receiver.

The transceiver 620 may receive a signal through a radio channel and output the received signal to the processor 610, and transmit a signal output from the processor 610 through the radio channel.

The memory 630 may store programs and data required for an operation of the base station. The memory 630 may also store control information or data included in a signal obtained by the base station. The memory 630 may include a storage medium, such as ROM, RAM, hard-disk, CD-ROM, DVD, and the like, or a combination thereof.

The processor 610 may control a series of processes such that the base station operates according to the above-described embodiment of the disclosure. For example, the processor 610 may control components of the base station to perform the method of managing barring according to an embodiment of the disclosure. For example, the transceiver 620 may receive a data signal including a control signal, and the processor 610 may determine a reception result for the data signal.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method performed by a user equipment (UE), the method comprising:
receiving configuration information including survival time state information indicating whether a data radio bearer (DRB) corresponding to the configuration information supports a survival time state;
receiving, configured retransmission grant addressed by configured scheduling-radio network temporary identifier (CS-RNTI); and
triggering activation of packet data convergence protocol (PDCP) duplication for all radio link control (RLC) entities configured for the DRB, based on the survival time state information and the configured retransmission grant.

2. The method of claim 1, wherein in case that a logical channel associated with the DRB is multiplexed in a medium access control (MAC) protocol data unit (PDU), the activation of the PDCP duplication is triggered.

3. The method of claim 1, wherein configuration information including survival time state information is received via radio resource control signal.

4. A method performed by a base station, the method comprising:
transmitting configuration information including survival time state information indicating whether a data radio bearer (DRB) corresponding to the configuration information supports a survival time state; and
transmitting, configured retransmission grant addressed by configured scheduling-radio network temporary identifier (CS-RNTI) to a user equipment(UE),
wherein activation of packet data convergence protocol (PDCP) duplication for all radio link control (RLC) entities configured for the DRB is triggered at the UE, based on the survival time state information and the configured retransmission grant.

5. The method of claim 4, wherein in case that a logical channel associated with the DRB is multiplexed in a medium access control (MAC) protocol data unit (PDU), the activation of the PDCP duplication is triggered.

6. The method of claim 4, wherein configuration information including survival time state information is received via radio resource control signal.

7. A user equipment (UE) comprising:
a transceiver; and
at least one processor coupled with the transceiver and configured to:
receive configuration information including survival time state information indicating whether a data radio bearer (DRB) corresponding to the configuration information supports a survival time state, receive, configured retransmission grant addressed by configured scheduling-radio network temporary identifier (CS-RNTI), and
trigger activation of packet data convergence protocol (PDCP) duplication for all radio link control (RLC) entities configured for the DRB, based on the survival time state information and the configured retransmission grant.

8. The UE of claim 7, wherein in case that a logical channel associated with the DRB is multiplexed in a medium access control (MAC) protocol data unit (PDU), the activation of the PDCP duplication is triggered.

9. The UE of claim 7, wherein configuration information including survival time state information is received via radio resource control signal.

10. A base station comprising:
a transceiver; and
at least one processor coupled with the transceiver and configured to:
transmit configuration information including survival time state information indicating whether a data radio bearer (DRB) corresponding to the configuration information supports a survival time state, and transmit, configured retransmission grant addressed by configured scheduling-radio network temporary identifier (CS-RNTI) to a user equipment (UE),
wherein activation of packet data convergence protocol (PDCP) duplication for all radio link control (RLC) entities configured for the DRB is triggered at the UE, based on the survival time state information and the configured retransmission grant.

11. The base station of claim 10, wherein in case that a logical channel associated with the DRB is multiplexed in a medium access control (MAC) protocol data unit (PDU), the activation of the PDCP duplication is triggered.

12. The base station of claim 10, wherein configuration information including survival time state information is received via radio resource control signal.
